(19) United States
(12) Patent Application Publication
(10) Pub. No.: US 2017/0232694 A1
(43) Pub. Date: Aug. 17, 2017

(54) LIGHTING OPTICS FOR LUMINAIRES

(71) Applicant: Scott S. YU, Tiburon, CA (US)

(72) Inventor: Scott S. YU, Tiburon, CA (US)

(21) Appl. No.: 15/467,836

(22) Filed: Mar. 23, 2017

Related U.S. Application Data
(63) Continuation of application No. 14/563,980, filed on Dec. 8, 2014.
(60) Provisional application No. 61/916,721, filed on Dec. 16, 2013.

(51) Int. Cl. B29D 11/00; F21V 5/04; F21K 9/69; B33Y 80/00; F21V 11/16; B29C 67/00; B33Y 10/00; F21V 7/00; F21K 9/90

(52) U.S. Cl. CPC B29D 11/00269; F21V 7/00; F21V 5/045; F21K 9/69; F21K 9/90; F21V 11/16; F21V 5/04; B29C 67/0059; B33Y 10/00; B33Y 80/00; F21Y 2115/10

(57) ABSTRACT

Disclosed herein are systems and methods for forming illumination affects through the use differing material disposed around various light sources. In some embodiments LED light sources are used. On the optical surface of the LED light source, lensing is effectuated to control the illumination from the light source. The lensing may be effectuated using maker tools such as 3D printing or micro-machining. Other embodiments of the methods described herein may be effected for shading and other illumination affects. Some embodiments include 3D printing of structures on circuit boards to effectuate lighting designs and control of LED light sources.

### PRIORITY

This application claims the benefit of provisional patent application 61/916,721 entitled “Lighting Optics for Luminaires” filed on Dec. 16, 2013, by the same inventor which is included by reference as if fully set forth herein. This application is also a continuation of application Ser. No. 14/563,980 filed Ser. No. 12/08/2014 by the same inventors.

### BACKGROUND

The present invention relates generally to luminaires and more particularly to a system and method for disposing LED and other light sources onto a luminaire such that the luminaire provides uniform lighting and conforms to a structure's metrics.

Lighting fixtures and luminaires are basic lighting devices used in homes, offices and a variety of industrial settings. One important criterion when selecting a lighting fixture is the performance of light fixture, one aspect of which is the light distribution or how the light is directed toward intended direction. Another important consideration is the glare control, or direct certain portion of the light away from unintended direction Visual attractiveness includes more than the appearance of the luminaire itself but also includes the aesthetic affect of the light provided by the luminaire, such as reducing visual luminance of light sources. Other criteria include low cost, ease of installation, performance, safety and legality. For industrial lighting the cost of installation may be more than the cost of the device because industrial lighting generally requires designs to satisfy many of the above listed criteria. For example, lighting in a warehouse may be required to meet minimum light intensity and safety requirements. This entails the use of a lighting designer or architect who would specify the source and type of luminaire desired for the specified task.

In addition, industrial lighting requires more detailed installation because industrial lighting is often installed as part of a larger design of a factory or workspace. The details of the lighting system must be specified in advance so that pricing, delivery and planning can be properly performed. Also industrial lighting often must meet higher local safety requirements. It is clear that ease of use and lower cost may be effectuated at the design, installation and usage stages of a lighting system.

Improvements that provide for an easier to design or an easier to install lighting system lower overall lighting costs. In addition, improvements that provide ease of manufacture may provide lower costs because fewer parts may be required and the manufacturer can gain from economies of scale. One area that has improved lighting designs is in the construction and use of light emitting diodes (LEDs) as light sources. With the development of high efficiency and high power LEDs it has become possible to incorporate LEDs in industrial lighting. LEDs are low-voltage lamps, requiring a constant direct current (DC) voltage or current to operate optimally. An individual LED may need 2-4V of DC power and several hundred milliamps (mA) of current. When LEDs are connected in series in an array, higher voltage is required. An LED driver acts as this power supply by converting incoming power to the proper low-voltage DC power required by the LEDs.

In view of the foregoing improvements to LED-based and other lighting designs that lower costs of manufacture, design or installation are beneficial.

### SUMMARY

Disclosed herein are systems and methods for forming illumination affects through the use differing material disposed around various light sources. In some embodiments LED light sources are used. On the optical surface of the LED light source, lensing is effectuated to control the illumination from the light source. The lensing may be effectuated using maker tools such as 3D printing or micro-machining. Other embodiments of the methods described herein may be effected for shading and other illumination affects. Some embodiments include 3D printing of structures on circuit boards to effectuate lighting designs and control of LED light sources.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows an embodiment of an LED luminaire according to certain aspects of the current disclosure.

FIG. 2 illustrates a substrate having a plurality of LEDs disposed on a surface of the substrate.

FIG. 3 illustrates another embodiment according to the present disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “3D printing” generally refers to the use of processes to make a three-dimensional object primarily through an additive processes wherein successive layers of material are laid down under computer control.

The term “lensing” generally refers to the use of optical lenses for controlling light radiation. The lensing may be effected using a piece of transparent substance, usually glass or plastic, having two opposite surfaces either both curved or one curved and one planar. However nothing in this disclosure should be read to limit the shape of any lens contemplated herein.

The term “luminaire” generally refers to a lighting fixture complete with the light source or lamp and connection to a power source. A Luminaire may optionally have a reflector for directing the light, an aperture (with or without a lens), the outer shell or housing for lamp alignment and protection, an electrical ballast, if required, However, for purposes of this disclosure, a luminaire may not require every part listed above, but may be comprised of only a portion of the listed components.

The term “luminance” generally refers to the brightness of a light source or an object that has been illuminated by a source.

The term “optical density” generally refers to ratio of the amount of radiation falling upon a material to the amount of radiation transmitted through the material.

The term “penumbra” generally refers to the partial shadow between the umbra and complete luminance, where part of the light source is visible.

The term “umbra” generally refers to the substantially dark shadow cast by an object.

### Detailed Description

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

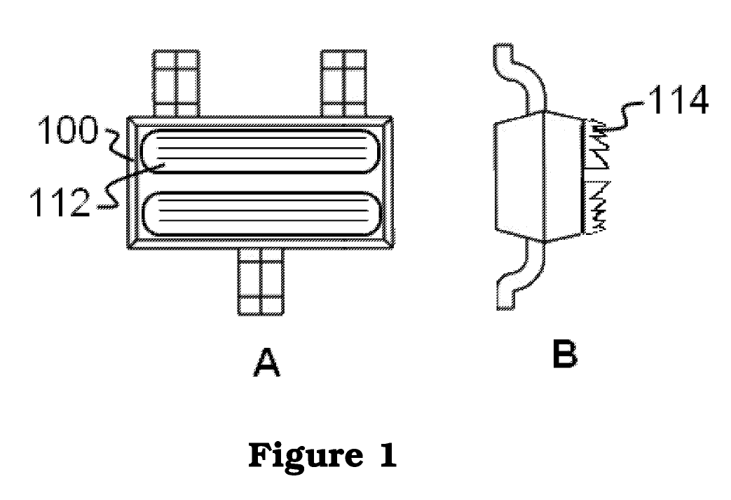

FIG. 1 shows an embodiment of an LED luminaire according to certain aspects of the current disclosure. In FIG. 1A a surface-mount LED module 110 is shown from the top. Disposed on the light emitting portion of the surface-mount LED module is lensing 112. The lensing has a height and structure to effectuate control of the light emitted by the LED. FIG. 1B shows a profile of the lensing 114. The lensing 112 is disposed on the surface to effectuate a Fresnel-type lens, which directs the light to a predetermined pattern. Fresnel lenses are employed to focus a light source. Although a Fresnel lens is shown in FIG. 1, nothing in this disclosure should be read as limiting the lensing 114 to Fresnel or Fresnel-type lensing. One having skill in the art will appreciate that other types of lenses may be effectuated using the techniques described herein.

In some embodiments the lensing may be applied to commercially available LED modules thus providing for customization of light patterns using off-the-shelf components and available tooling such as 3D printing. Transparent material (such as RGD720 or VeroClear-RGD810) are multipurpose transparent photopolymers that provide for clear plastics structures using 3D printing. In addition acrylic material may be employed, however clear acrylic material may need real time conditioning to minimize bubbles and cracking. Certain embodiments may include combinations of relatively higher or lower optical density. Moreover, semi-transparent and translucent materials may also be employed.

One having skill in the art will appreciate that the use of micro-machining or 3D printing provides for lens shaping to achieve a desired optical pattern which may include focusing the light or diffusing the light. In some embodiments the lensing may be applied to the surface of commercially available LEDs by disposing lensing over an existing seal on the LED. This process may be effectuated by laying down an initial thin coat of material and then repeatedly laying additional coats of material over the initial coating.

Although a Fresnel lens is depicted in FIG. 1 for example purposes, this disclosure should not be read as limiting in any way. For example and without limitation, structures such as reflectors, baffles and the like may be effectuated on the optical surface of a light source such as an LED. Moreover different materials may be combined to create shading and optical patterns to effectuate diffusing. As light from the lamp passes through the lens, a small percentage of a visible portion of the light is diffused when the light shines through a sparse layer of shading whereas more light is blocked when passing through the highly dense layer of shading. Combining materials through 3D printing techniques provides for different optical densities and colors of material to be disposed on the LED surface to create diffusion patterns and other lighting affects.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

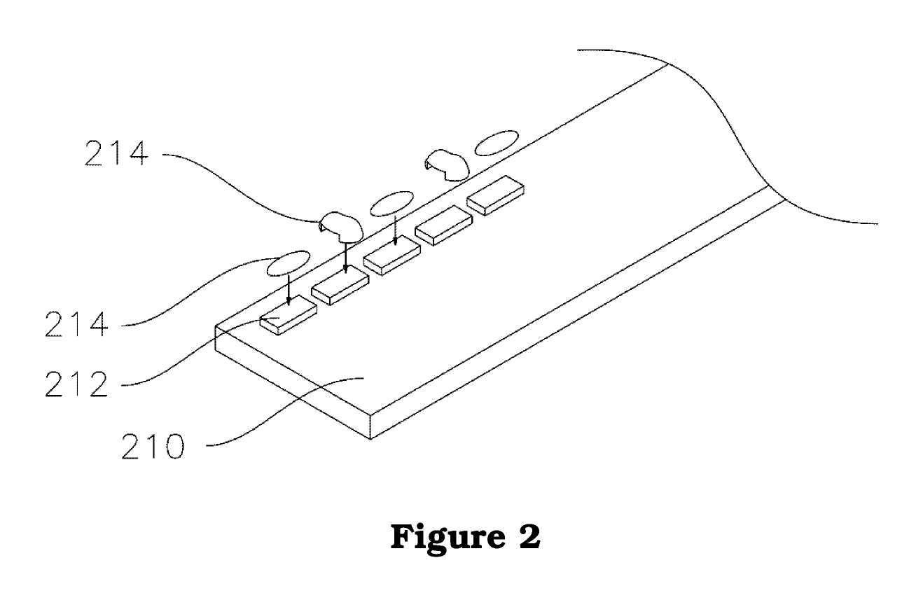

FIG. 2 illustrates a substrate 210, such as a circuit board, having a plurality of LEDs 212 disposed on a surface of the substrate 210. The LEDs are shown spaced apart. Disposed on the surface of the LEDs 212 are optical structures 214 designed to manipulate the light emitting from the LEDs 212. In some embodiments the structures 214 may be optically dense such that no light passes through the structure 214, thus providing for shading and baffle affects.

Other embodiments may include reflective material disposed at angles to bend the emitted light into a predetermined pattern such as a reflector. These embodiments may also include optical coating techniques combined with 3D printing to create certain lighting effects. Other embodiments may involve disposing shapes to provide for diffusion of the light emitting from the LEDs 212. This may include 3D printing of various shapes along the substrate 210 in relationship to the location of the LEDs 212. For example and without limitation, optically dense structures may be disposed in an asymmetrical pattern between the LEDs 212 such that direct light from the LEDs 212 does not radiate off a portion of the substrate, but only indirect light radiation passes.

In FIG. 2 the LEDs 212 may each have disposed on them different shaped structures 214 providing for different lighting effects. For example and without limitation, optical structures 214 on the LEDs 212 placed near the end of the substrate 210 may bend light at a different angle then optical structures 214 on the LEDs 212 placed towards the center of the substrate 210. This may allow for optical designers to minimize “hotspot” effects from varying degrees of light.

In some embodiments the structures 214 may cover all of the substrate 210 such that the entire volume of light emitted by the light sources passes through the structure 214. These embodiments may include areas of differing optical density to effectuate shading, coloring and diffusion of the emitted light. Creator technologies such as 3D printing may effectuate a single structure with varying degrees of optical density coordinated to effectuate a specific design result or to create structures that vary optical density according to the wavelength of light.

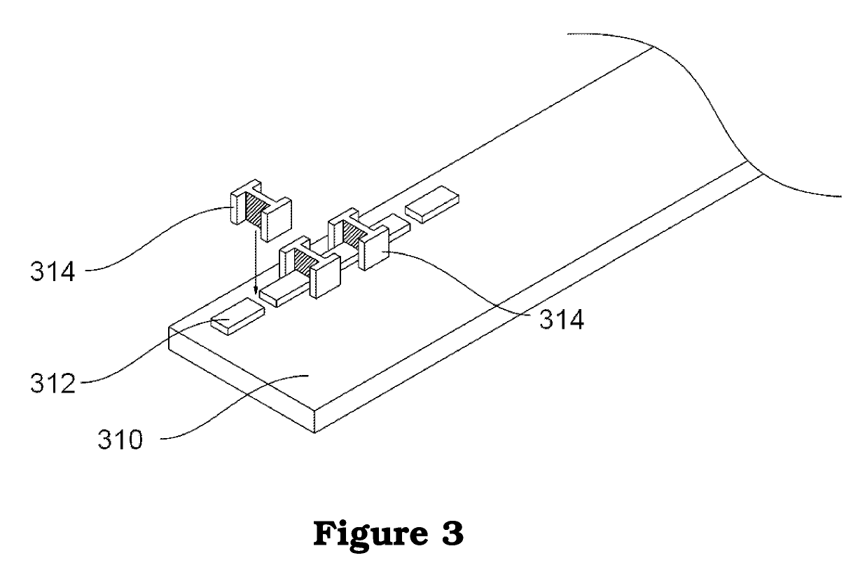

FIG. 3 illustrates another embodiment according to the present disclosure. In FIG. 3 a substrate 310, such as a circuit board, has a plurality of light sources 312 disposed on a surface of the substrate 310. The light sources are shown having a space separating them from each other. Disposed on the surface of the substrate 310, in the space between the light source 312 are optical structures 314 designed to manipulate the light emitting from the light sources 312. In some embodiments the structures 314 may be optically dense such that no light passes through structures 314, thus providing for shading effects such as baffling (as shown).

Variations in optical density provide for different shading effects. For example and without limitation if some structures are clear, or of a different shape, the light pattern emitted from the light sources 312 will be modified. One having skill in the art will appreciate that the structures 314 may be effected using 3D printing or micro-machining processes during the manufacture of the device of FIG. 3 or after manufacture for customization according to where the device may be employed.

In other embodiments structures may be 3D printed along the length of an LED board using different optics with different distribution angles that allow for a desired lighting effect. For example, and without limitation, a particular distribution angle may be achieved by disposing a first set of structures 314 with a very wide light distribution angle in the middle of the substrate 210, coupled with disposing a second set of structures 314 with a distribution angle in the form of a sharp cut off angle at the end of the substrate 310. Thus having the affect of spreading light from the middle of substrate 310 at one angle while having a very pronounced square pattern at the end of the substrate 310.

Other examples include a two-channel LED board where a first array of LEDs may have a narrow beam angle, while a second array of LEDs may have a wide beam angle, thus allowing for dynamic control of beam output by powering different arrays of LEDs. In other embodiments optical structures may be printed in between slats of a micro-baffle placed over the light sources thus creating different optical affects in addition to the baffling.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A computer numerically-controlled method of additive deposition of semi-transparent material, the method comprising:
repeatedly disposing a thin layer of semi-transparent material on a transparent illuminative cover of a light source to effectuate a lens structure, said lens structure including at least one curved surface;
wherein the light source is disposed on a substrate,
wherein the lens structure is operative to focus light emitted from the light source in a predetermined pattern and direction.

3. The method of claim 1 wherein the semi-transparent material is colored and is operative to narrow the frequency ranges of light emitted from the light source.

3. The method of claim 1 wherein the semi-transparent material is a photopolymer or an acrylic material.

4. The method of claim 1, further comprising:
disposing the light source proximate to a first portion of the substrate,
wherein the lens structure is operative to reflect light at a first angle;
disposing a second light source proximate to a second portion of the substrate; and
repeatedly disposing a thin layer of semi-transparent material on a transparent illuminative cover of the second light source to effectuate a second lens structure,
wherein the second lens structure is operative to reflect light at a second angle.

5. The method of claim 1, wherein repeatedly disposing a thin layer of semi-transparent material on a transparent illuminative cover of a light source to effectuate a lens structure consists of a first and second series of thin layers,
wherein at least one of the thin layers of the first series operates as a structurally-secure foundation whereupon a second series of thin layers is deposited, and
wherein the at least one of the thin layers of the first series is composed of a semi-transparent material with a greater structural integrity than at least one of the thin layers of the second series.

6. The device of claim 1 wherein the light source is a light emitting diode.

7. The device of claim 1 wherein the lens structure is a Fresnel lens.

8. A method comprising:
disposing a light source on a substrate;
repeatedly disposing a thin layer of optically dense material on the substrate with the effect of creating a baffle structure, said baffle structure operative to at least partially reflect light emitted from a light source.

9. The method of claim 8 wherein repeatedly disposing a thin layer of semi-transparent material on the structure includes disposing a first and a second series of thin layers,
wherein the first series of thin layers operate as a structurally-secure foundation whereupon a second series of thin layers is deposited,
wherein the first series of thin layers is composed of a semi-transparent material with a greater structural integrity than the second series of thin layers.

10. The method of claim 9 wherein the aggregation of the layers comprising the baffle structure is operative to effectuate a relatively high optical density,
wherein the baffle structure is operative to re-direct a majority of the light emitted from the light sources.

11. The method of claim 9 wherein the aggregation of the layers comprising the baffle structure is operative to incur a relatively high optical reflectivity,
where in the baffle structure is operative to reflect a majority of the light emitted from the light sources in a predetermined ray distribution pattern.

12. A method comprising:
disposing a first light source proximate to a first portion of a substrate;
disposing a second light source proximate to a second portion of the substrate;
repeatedly disposing a thin layer of semi-transparent material on a substantially transparent surface of the first light source to effectuate a baffle structure,
wherein the aggregation of the layers comprising the baffle structure is operative to incur a relatively high optical density.

13. The method of claim 12 further including:
repeatedly disposing a thin layer of semi-transparent material on a substantially transparent surface of the second light source to effectuate a second baffle structure,
wherein the aggregation of the layers comprising the second baffle structure is operative to incur a relatively high optical density.

14. The method of claim 12 wherein the first light source is a light emitting diode.

15. The method of claim 12 wherein the optically dense material is a photopolymer or an acrylic material.
